(19) United States
(12) Patent Application Publication
(10) Pub. No.: US 2004/0101756 A1
(43) Pub. Date: May 27, 2004

(54) Negative electrode for non-aqueous secondary cell, non-aqueous secondary cell comprising the same, method for producing the same and electronic device comprising non-aqueous secondary cell

(76) Inventors: Toshihiro Koyama, Daejeon (KR); Fusaji Kita, Osaka (JP)

Correspondence Address: BIRCH STEWART KOLASCH & BIRCH, PO BOX 747, FALLS CHURCH, VA, 22040-0747, US

(21) Appl. No.: 10/715,363

(22) Filed: Nov. 19, 2003

(30) Foreign Application Priority Data
Nov. 19, 2002 (JP) P2002-335723

(51) Int. Cl. H01M 4/58; H01M 4/62

(52) U.S. Cl. 429/231.8; 429/217; 252/182.1

(57) ABSTRACT

A negative electrode for a non-aqueous secondary cell comprising graphite, carbon black and an aqueous binder, wherein said carbon black comprises particles having an aspect ratio of 1.0 to 5.0 and a largest particle size of 10 μm or less, which electrode has a low internal resistance and good low temperature properties.

The present application claims priority under 35 USC § 119(d) on application 2002-335723, which was filed in Japan on Nov. 19, 2002 and is incorporated herein by reference in its entirety.

### FIELD OF THE INVENTION

The present invention relates to a negative electrode for a non-aqueous secondary cell, a non-aqueous secondary cell comprising the same, a method for producing such a negative electrode, and an electronic device comprising a non-aqueous secondary cell.

### BACKGROUND OF THE INVENTION

Demand for non-aqueous secondary cells such as lithium ion secondary cells increases year by year because of their light weight, high voltage, high energy density and high output. Non-aqueous secondary cells are widely installed in the most-advanced portable electronic devices such as mobile phones, video cameras, etc. With recent remarkable increases in the performance of those electronic devices, the non-aqueous secondary cells installed in the high-performance electronic devices are required to have a further improved performance. Thus, cells having a higher capacity and a lower internal resistance, for example, cells having a good discharge property at a low temperature of −10° C., have been increasingly desired.

To increase the capacity of a non-aqueous secondary cell, it is effective to use a negative electrode active material having a high capacity. To this end, it is proposed to use natural or artificial graphite with a high capacity as a negative electrode active material (JP-A-2001-357849). However, most graphite materials with a high capacity have a highly grown lamellar structure and thus a high degree of graphitization and often have a flake form. Flake graphite has a small number of sites through which lithium ions intercalate between the layers thereof, that is, edge planes. Therefore, when flake graphite is used as a negative electrode active material of a lithium ion secondary cell, the performance of the cell in the case of discharging at a high current deteriorates, that is, its high rate discharge properties deteriorate.

To solve such problems of lithium ion cells comprising flake graphite as a negative electrode active material, artificial graphite, which is produced by calcining mesophase carbon, is used as a spherical graphite having no lamellar structure. However, the spherical graphite has a smaller capacity than flake graphite and is not suited for increasing the capacity of the cell.

Under such circumstances, JP-A-2001-185149 discloses graphite having a specific surface area of at least 2.5 m²/g and a crystal spacing d₀₀₂ (spacing of (002) planes of a crystal) is 0.3370 nm or less, and achieves a cell having a good balance between a high capacity and high rate discharge properties.

Furthermore, JP-A-2001-216970, JP-A-2002-231250, JP-A-2002-8655 and JP-A-2000-348719 disclose the addition of carbon black as an electrically conducting aid to improve the internal resistance and low-temperature properties of non-aqueous secondary cells.

In general, the negative electrode of a lithium ion secondary cell contains a binder to bind the particles of the active material to maintain the shaped body of the negative electrode. The binders include solvent-type binders which use organic solvents as liquid media, such as polyvinylidene fluoride, and aqueous binders which use water as a liquid medium such as the mixture of a styrene-butadiene rubber and carboxymethylcellulose. In these years, the aqueous binders are actively used, since they have a larger binding effect than the solvent-type binders and increase the ratio of the active material in the same volume of the electrode and in turn the capacity of the electrode.

When the aqueous binder is used in a negative electrode comprising graphite and carbon black, carbon black is not uniformly dispersed in water since it is hydrophobic. Instead, the carbon black particles form into lumps, so that no homogeneous coating is obtained and/or the lumps of carbon black cause streaks in the coated film. Therefore, the addition of carbon black may not improve the internal resistance or temperature properties. When a dispersant or a surfactant is used to solve such problems, the amount of graphite per unit volume decreases so that the capacity tends to decrease and the internal resistance tends to increase.

Hitherto it has been difficult to produce a negative electrode having a high capacity, a low internal resistance and good low-temperature performance using graphite, carbon black and an aqueous binder.

A negative electrode comprising graphite for a lithium ion secondary cell is produced by applying a negative electrode coating comprising graphite; an aqueous binder and water to a negative electrode collector made of a metal foil of copper, nickel, stainless steel or titanium having a thickness of 8 to 15 μm, drying the coating applied to form a layer: of the negative electrode mixture, and press-forming the negative electrode with rotating rolls in a calendering step. If the negative electrode coating contains no carbon black, parts of the negative electrode coating layer may be transferred to the rolls in the press-forming step to form defects. Additional transfers to the rolls can cause new and/or larger defects, with the number of defects accelerating and increasing by the transfer of the mixture to the rolls as the calendering step proceeds. Such a problem may be solved by washing the rolls onto which the mixture is transferred, to remove the transferred mixture, whenever such a transfer occurs. However, the throughput per unit time decreases with such a washing procedure and thus productivity deteriorates.

### SUMMARY OF THE INVENTION

One object of the present invention is to provide a negative electrode for a non-aqueous secondary cell, which can solve the above problems of conventional negative electrodes.

According to a first aspect thereof, the present invention provides a negative electrode for a non-aqueous secondary cell comprising graphite, carbon black and an aqueous binder, wherein said carbon black comprises particles having an aspect ratio of 1.0 to 5.0, and a largest particle size of 10 μm or less.

According to a second aspect, the present invention provides a non-aqueous secondary cell comprising a positive electrode, a negative electrode and a non-aqueous electrolyte, wherein said negative electrode comprises graphite, carbon black comprising particles having an aspect ratio of 1.0 to 5.0, and a largest particle size of 10 μm or less, and an aqueous binder.

According to a third aspect, the present invention provides a method for producing a negative electrode for a non-aqueous secondary cell comprising the steps of:

mixing graphite, carbon black comprising particles 25 having an aspect ratio of 1.0 to 5.0 and a largest particle size of 10 μm or less, and an aqueous binder to prepare a negative electrode coating,

applying the negative electrode coating on a substrate of the negative electrode,

drying the applied negative electrode coating, and

press-forming the coating.

According to a fourth aspect, the present invention provides an electronic device comprising a non-aqueous secondary cell which comprises a positive electrode, a negative electrode and a non-aqueous electrolyte, wherein said negative electrode comprises graphite, carbon black comprising particles having an aspect ratio of 1.0 to 5.0 and a largest particle size of 10 μm or less, and an aqueous binder.

### BRIEF DESCRIPTION OF THE DRAWINGS

FIG. 1A is a plan view of one example of a non-aqueous secondary cell according to the present invention;

FIG. 1B is a partially cross-sectional view of the non-aqueous secondary cell of FIG. 1A; and

FIG. 2 is a perspective view of the non-aqueous secondary cell of FIGS. 1A and 1B.

### DETAILED DESCRIPTION OF THE INVENTION

The negative electrode for a non-aqueous secondary cell according to the present invention comprises graphite, carbon black and an aqueous binder, wherein the carbon black has an aspect ratio (a ratio of a longer particle size to a shorter particle size) of 1.0 to 5.0, preferably 1.0 to 2.5, and wherein the largest particle size of the carbon black does not exceed 10 μm preferably 2 μm, more preferably 1 μm.

The terms “particle” and/or “particles” of carbon black, as used herein, include primary particles, and also secondary particles of carbon black that are agglomerates of the primary particles.

When carbon black has the above particle size characteristics, it does not deteriorate the properties of the negative electrode coating comprising an aqueous binder. Thus, the negative electrode formed has a high capacity, a high energy density, a low internal resistance, and good low-temperature characteristics.

When the largest particle size of carbon black exceeds 10 μm, the particle size of carbon black does not well match with the particle size of graphite, since the average particle size of graphite is usually from 15 to 30 μm, and as such productivity may not be increased by the addition of carbon black, or the internal resistance and the low-temperature characteristics may not sufficiently be improved. In addition, it is highly probable that the negative electrode coating may contain agglomerates of carbon black particles when the particle size of carbon black exceeds 10 μm, so that the properties of the coating greatly deteriorate. The lower limit of the largest particle size of carbon black is preferably 0.05 μm to prevent the expansion of the negative electrode during storage, when the negative electrode is assembled in the non-aqueous secondary cell.

Herein, the aspect ratio of carbon black is determined as follows:

The particles of carbon black are observed with a scanning electron microscope. The longest size of each particle (primary or secondary particle) is used as a longer particle size. Among the sizes in the direction perpendicular to the direction of the longer particle size, the maximum size is used as a shorter particle size. Then, the ratio of the longer particle size to the shorter particle size is used as an aspect ratio.

The amount of carbon black having the above particle size characteristics is preferably at least 10% by weight, more preferably at least 30% by weight, most preferably at least 60% by weight, based on the whole (total) weight of carbon black.

“Carbon black” means amorphous carbon such as acetylene black, ketchen black, etc. In the present invention, any conventional carbon black may be used insofar as the above particle size characteristics are met.

Carbon black is often processed to form granular particles having a particle size of about a few hundred um to about 1 mm to improve the handling of carbon black. When a negative electrode coating is prepared using such granular particles of carbon black, the surfaces of the granular particles are coated with the aqueous binder such as carboxymethylcellulose without being disintegrated. Thus, the negative electrode coating sometimes contains undispersed granular particles having a particle size of about a few hundred μm to about 1 mm. In such a case, the granular particles of carbon black should beforehand be milled with an apparatus, which can apply an impact on the particles such as a Henschel mixer, a jet mill, a hammer mill and the like, to provide particles having an aspect ratio of 1.0 to 5.0 and a largest particle size of 10 μm or less.

The amount of carbon black to be added is preferably at least 00.05;% by weight, more preferably at least 0.1% by weight, based on the final solid content of the negative electrode coating. In this range, the transfer of the electrode mixture to the roll can be effectively prevented. When the amount of carbon black is too large, the amount of the negative electrode active material (graphite) per unit volume decreases. Thus, the upper limit of the amount of carbon black is preferably 3.0% by weight.

An aqueous binder means a binder which uses water as a solvent or a dispersion medium. Examples of the aqueous binder are thermoplastic resins, polymers having rubbery elasticity, polysaccharides, etc. Specific examples of the aqueous binder include polytetrafluoroethylene, polyethylene, polypropylene, ethylene-propylene copolymers, styrene-butadiene rubbers, polybutadiene, butyl rubber, fluororubber, polyethylene oxide, polyvinylpyrrolidone, polyepichlorohydrin, polyphosphazene, polyacrylonitrile, polystyrene, ethylene-propylene-diene copolymers, polyvinylpyridine, chlorosulfonated polyethylene, polyester resin, acrylic resin, phenol resin, epoxy resin, polyvinyl alcohol, cellulose resins (e.g. carboxymethylcellulose, hydroxypropylcellulose, etc.), and the like.

Among them, a mixed binder of styrene-butadiene rubber and carboxymethylcellulose is preferable, since it has a large binding force.

When the amount of the aqueous binder is too low, the adhesion of the negative electrode mixture layer to the collector layer decreases so that the negative electrode mixture layer may become easily peeled from the collector. Therefore, the productivity of the negative electrode and the cell decreases, or short circuits may form inside the cell. It is known that the internal resistance increases when the amount of the aqueous binder is too large. Accordingly, the amount of the aqueous binder is preferably from 1.0 to 3.0% by weight, more preferably from 1.5 to 2.5% by weight, based on the total weight of the solids.

As graphite, artificial graphite is preferably used. The artificial graphite may be produced by mixing a basic material of graphite, a binder material which can be graphitized and binds the particles of the basic material, and optionally a catalyst for graphitization, and calcining the mixture to graphitize the basic material and the binder material. The artificial graphite may be used as such, or as a mixture with natural graphite or other artificial graphite.

Preferred examples of the basic material of graphite include coke materials such as needle coke, mosaic coke, etc., and graphite materials such as natural graphite, artificial graphite, etc.

Preferred examples of the binder material include tar, pitch, resins, etc.

Examples of the catalyst for graphitization include iron, nickel, boron, silicon, and their oxides, carbides., nitrides, etc.

The basic material, the binder material and the catalyst are mixed at a temperature of 50 to 350° C. at which the binder material is softened or molten, and calcined at a temperature of 500 to 2000° C. Thereafter, the calcined mixture is optionally milled to adjust its particle size, and then graphitized at a temperature of 2500 to 3200° C.

The graphite has a specific surface area-of at least 2.5 m²/g and a crystal spacing d₀₀₂ of 0.3370 nm or less, preferably 0.3365 nm or less, when measured by a X-ray diffraction method.

When the graphite has a specific surface area within the above range, it has good high rate discharge characteristics. When the specific surface area of the graphite is too large, the volume of the voids in the particles becomes so large that the capacity tends to decrease. Therefore, the specific surface area of the graphite preferably does not exceed 5 m²/g.

When a crystal spacing d₀₀₂ (spacing of (002) planes of the crystal) is within the above range, the crystallinity of the graphite increases so that the negative electrode can have a high capacity. As a crystal spacing d₀₀₂ decreases, the crystallinity of the graphite increases and thus the capacity of the negative electrode increases. Therefore, graphite having a crystal spacing d₀₀₂ of 0.3354 nm, which is the theoretical limit of the spacing d₀₀₂, may be used.

The average particle size of graphite is preferably from 15 to 30 μm.

When graphite having the above properties is combined with a carbon black as described above, the negative electrode has good characteristics and, in turn, the cell has good performance.

The density of the negative electrode is preferably at least 1.50 g/cm³, since the non-aqueous secondary cell comprising such a negative electrode has a high capacity.

In one embodiment of the present invention, a negative electrode for a non-aqueous secondary cell according to the present invention is produced as follows. In this embodiment, a negative electrode comprising a graphite as described above, carbon black and an aqueous binder is produced.

Carbon black having an aspect ratio of 1.0 to 5.0 and having a largest particle size of 10 μm or less is provided and mixed with graphite and an aqueous binder to prepare a negative electrode coating. The coating is applied to a substrate, dried and press-formed. This production method has good productivity.

The specific examples of the above production method are the following methods (1), (2) and (3). Among them, the method (1) is preferable since its operation is considered to be easy to apply and uses fewer steps.

(1) Firstly, graphite and carbon black are dry mixed by charging graphite and carbon black in a vessel (mixing vessel) and mixing them using, for example, a planetary mixer, Ledige mixer, etc. After dry mixing, an aqueous binder such as styrene-butadiene rubber and carboxymethylcellulose, and water are mixed with the mixture of graphite and carbon black to prepare a negative electrode paste. To the paste, additional water is optionally added to obtain a negative electrode coating. In this case, the aqueous binder may be beforehand dissolved or dispersed in water and then mixed with other components.

(2) Firstly, carboxymethylcellulose is dissolved or dispersed in water, and then only carbon black is dispersed in the aqueous-mixture of the binder, and graphite is added. Thereafter, styrene-butadiene rubber is added to obtain a negative electrode coating.

(3) Firstly, carboxymethylcellulose is dissolved or dispersed in water, and then graphite is dispersed in the aqueous mixture of the binder, and carbon black is added. Thereafter, styrene-butadiene rubber is added to obtain a negative electrode coating.

The negative electrode coating prepared by one of the above methods (1), (2) and (3) is applied to a negative electrode collector which functions also as a substrate and is dried to form a layer of the negative electrode mixture, which is then press-formed to produce a negative electrode.

If a negative electrode is produced using no carbon black, the layer of the negative electrode mixture is easily transferred to rolls in the step of press-forming when the electrode has a density of 1.50 g/cm³ or more. When a negative electrode contains carbon black as in the present invention, the transfer of the layer of the negative electrode mixture to the rolls is suppressed. Therefore, to produce a negative electrode having a high capacity, an electrode density is preferably at least 1.50 g/cm³, more preferably at least 1.55 g/cm³, most preferably at least 1.60 g/cm³. However, when the electrode density is too high, the layer of the negative electrode mixture tends to be transferred to the rolls again, preferably the electrode density of the negative electrode does not exceed 1.80 g/cm³.

According to the observation of the cross section and surface of the negative electrode with a scanning electron microphotograph, it has been revealed that some of the carbon black is segregated in the surface area of the negative electrode. This segregation of the carbon black may have some effect to suppress the transfer of the layer of the negative electrode mixture to the rolls.

One example of the non-aqueous secondary cell according to the present invention will be explained by making reference to the drawings.

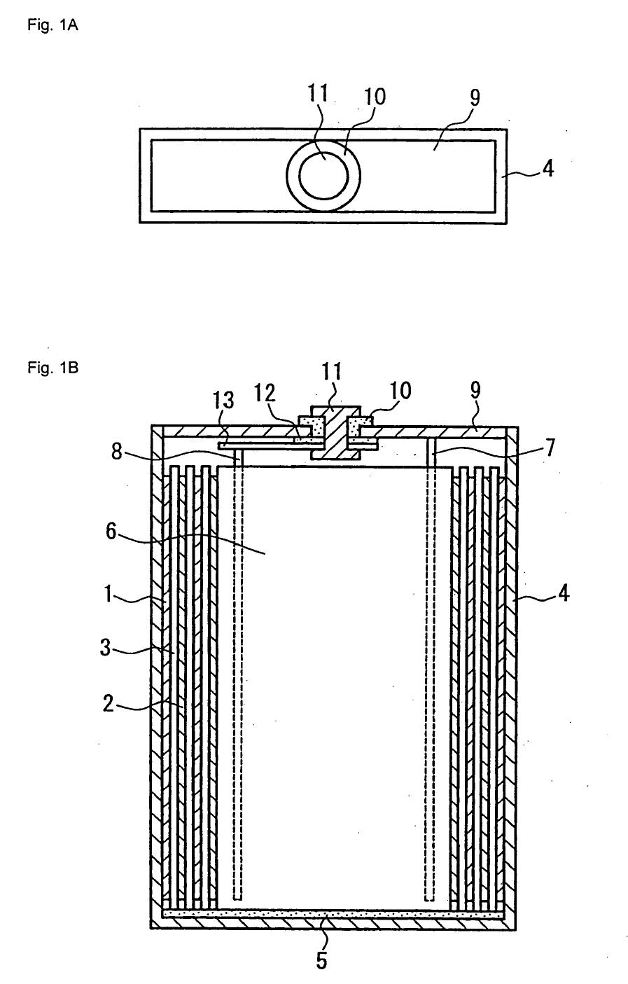

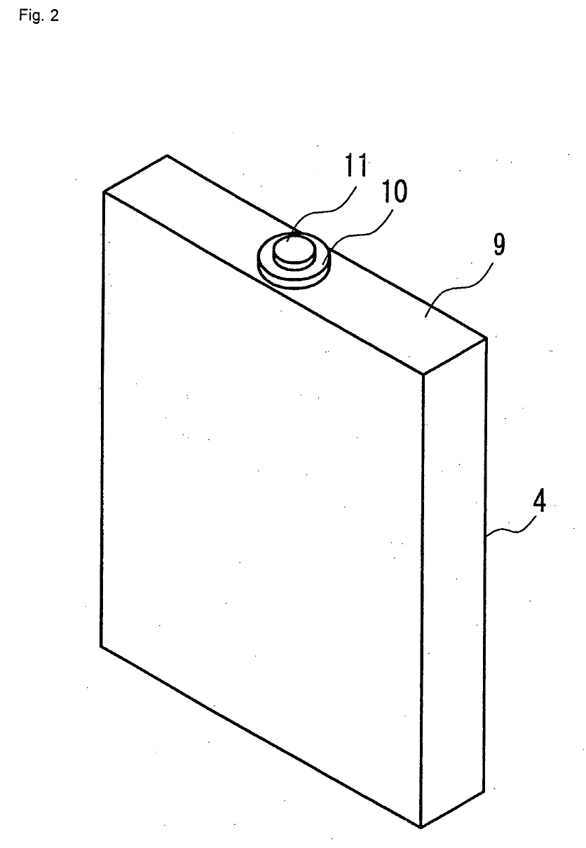

FIGS. 1A and 1B are a plan view and a partially cross-sectional view respectively, of one example of a non-aqueous secondary cell according to the present invention, and FIG. 2 is a perspective view of this non-aqueous secondary cells.

FIG. 2 shows that the non-aqueous secondary cell of this example is a prismatic cell.

Referring to FIGS. 1A and 1B, the non-aqueous secondary cell of this example comprises positive electrode 1, negative electrode 2 and separator 3. Negative electrode 2 is a negative electrode for a non-aqueous secondary cell explained above. Thereby, the non-aqueous secondary cell has a low internal resistance and good low-temperature characteristics.

Positive electrode 1 and negative electrode 2 are spirally wound with inserting separator 3 between them and pressed to form flat-form wound electrode laminate 6, which is installed in cell case 4 together with an organic electrolytic solution. For simplicity, FIGS. 1A and 1B do not show metal foils used as the collectors of positive electrode 1 and negative electrode 2, and the electrolytic solution. In FIG. 1B, the inner part of electrode laminate 6 is not cross-sectioned. In general, an electrolyte layer comprises a separator and an electrolytic solution impregnated in the separator.

Cell case 4 is usually formed of a metal such as an aluminum alloy, and functions as an exterior member of the cell. Cell case 4 also functions as the terminal of the positive electrode.

At the bottom of cell case 4, insulator 5, which is usually made of a synthetic resin such as polytetrafluoroethylene, is provided.

Lead member 7 for a positive electrode and lead member 8 for a negative electrode are connected with positive electrode 1 and negative electrode 2, respectively, and drawn from flat-form wound electrode laminate 6 consisting of positive electrode 1, negative electrode 2 and separator 3. Metal terminal 11 is attached to metal lid plate 9 which seals the opening of cell case 4 through insulation packing 10. With terminal 11, metal lead plate 13 is attached through insulator 12. Usually, the metal terminal is made of stainless steel, the lid plate is usually made of an aluminum alloy, the insulation packing is made of a synthetic resin such as polypropylene, and the lead plate is made of stainless steel. Furthermore, lid plate 9 is inserted in the opening of cell case 4, and the mated parts of the lid plate and cell case are welded to close the opening of cell case 4 so that the interior of the cell is sealed.

In FIG. 1, lead member 7 for a positive electrode is welded directly with lid plate 9 so that cell case 4 and lid plate 9 together function as the terminal of the positive electrode, while lead member 8 for negative electrode is welded to lead plate 13 and lead member 8 and terminal 11 are electrically connected with lead plate 13 so that terminal 11 functions as the terminal of the negative electrode. However, depending of the material of cell case 4, the terminals may function reversely.

In this example of the cell, a metal oxide which occludes and liberates Li ions is used as a positive electrode active material. Any metal oxide which is conventionally used as the positive electrode material of a non-aqueous secondary cell may be used. Specific examples of the metal oxide include LiCoO₂, LiMn₂O₄, LiNiO₂, LiₓNi_{y}Mn_{z}Oₐ, etc.

The positive electrode may be produced as follows:

To the above positive electrode active material, a binder such as polyvinylidene fluoride, polytetrafluoroethylene, etc., a viscosity aid, and optionally a conductive aid such as flake graphite, carbon black, etc. are mixed, and then a solvent is added to the mixture to prepare a positive electrode coating. The positive electrode coating is then applied to appositive electrode collector which functions also as a substrate and dried to form a layer of the positive electrode mixture, which is then optionally press-formed to produce a positive electrode. In this case, the binder and viscosity aid may be beforehand dissolved or dispersed in water and then mixed with the positive electrode active material, etc.

The positive electrode may be produced by a method other than the above method.

The kind of solvent of the electrolytic solution is not limited, though a linear ester is preferably used. Examples of the linear ester are linear esters having a COO— bond such as dimethyl carbonate, diethyl carbonate, ethylmethyl carbonate, ethyl acetate, methyl propionate, etc.

Besides the linear ester, an ester having a high dielectric constant is preferably used. Examples of the ester having a high dielectric constant include ethylene carbonate, propylene carbonate, butylene carbonate, γ-butyrolactone, ethylene glycol sulfite, etc. In particular, a cyclic ester such as ethylene carbonate, propylene carbonates etc. is preferable. Ethylene carbonate is most, preferable.

Examples of solvents which may be used in addition to the ester having a high dielectric constant include 1,2-dimethoxyethane, 1,3-dioxolane, tetrahydrofuran 2-methyltetrahydrofuran, diethyl ether, etc. Furthermore, organic amine and imide solvents, and sulfur or fluorine-containing organic solvents may be used.

The electrolytic solution may be prepared by dissolving an electrolytic salt such as a lithium salt in a non-aqueous solvent comprising the above organic solvent. Examples of the electrolytic salt include LiPF₆, LiClO₄, LiBF₄, LiCₙF₂ₙ₊₁SO₃ (n≧2), (RfSO₂) (Rf′SO₂)NLi wherein Rf and Rf′ represent independently from one another a fluoroalkyl group having 1 to 8 carbon atoms, LiCF₃CO₂, LiN(CF₃SO₂)₂, LiC(CF₃SO₂)₃, LiAsF₆, LiSbF₆, LiB₁₀Cl₁₀, lithium lower fatty carboxylate, LiAlCl₄, LiCl, LiBr, LiI, chloroboran lithium, lithium tetraphenylborate (LiB(C₆H₅)₄), etc. They may be used independently or as a mixture thereof. The concentration of the electrolytic salt in the electrolytic solution is not limited, and is preferably from 0.6 to 1.5 mol/dm³.

In one preferred embodiment, the electrolytic solution contains an aryl compound having an alkyl or cycloalkyl group-bonded to a benzene ring as an additive. Such an aryl compound may improve the safety of the cell in the case of overcharging. Examples of such an aryl compound having an alkyl group bonded to a benzene ring include cyclohexylbenzene, isopropylbenzene, n-butylbenzene, octylbenzene, toluene, xylene, etc. Among these aryl compounds, a compound in which the carbon atom of an alkyl group bonded directly to the benzene ring has at least one hydrogen atom is preferable to improve the safety of the cell in the case of overcharging. The alkyl group is preferably a relatively long chain one having at least 4 carbon atoms, more preferably a bulky one having a branched structure. For such a reason, cyclohexylbenzene is preferable.

When the cell is overcharged, the aryl compound having an alkyl group bonded to a benzene ring is oxidized and polymerized on the positive electrode side to form an oligomer such as a dimer, a trimer, etc. or a polymer on the positive electrode, and such an oligomer-or a polymer-forms a film on the positive electrode and may suppress overcharging.

As the amount of the aryl compound having an alkyl group bonded to a benzene ring in the electrolytic solution increases, the effect to improve the safety of the cell increases. However, if the amount of the aryl compound having an alkyl group bonded to a benzene ring is too large, the ionic conductivity of the electrolytic solution tends to be decreased.

The lower limit of the amount of the aryl compound having an alkyl group bonded to a benzene ring is preferably 1%, more preferably 2% based on the weight of the electrolytic solution. The upper limit of the amount of aryl compound having an alkyl group-bonded to a benzene ring is preferably 10%, more preferably 5% based on the weight of the electrolytic solution.

The electrolytic solution may contain an additive which improves cycle properties of the cell such as vinylene carbonate, etc. in addition to the aryl compound having an alkyl group bonded to a benzene ring. The amount of such an additive may be 0.1 to 5% by weight, preferably 0.1 to 2% by weight, based on the weight of the electrolytic solution.

According to the present invention, the non-aqueous secondary cell of the present invention is preferably assembled in an electronic device. Thereby, the electronic device has improved low-temperature characteristics.

The electronic device may be any conventionally used device, and examples of the electronic device include mobile phones, notebook personal computers, personal data assistants (PDA), video cam recorders, portable audio players such as MD or CD players, digital cameras, small-sized medical equipment, emergency communication apparatuses, portable game players, portable measuring instruments, portable transceivers, small liquid crystal TVs, small printers, etc. Among them, those used in a low temperature condition of 0° C. or less, in particular, −10° C. or less, and portable ones having a weight of 10 kg or less are preferably equipped with the cell of the present invention.

When the non-aqueous secondary cell of the present invention is set in the electronic device, a final discharge voltage of the cell is preferably at least 3.1 V, more preferably at least 3.2 V, most preferably at least 3.3 V. As the final discharge voltage increases, the usable time of the non-aqueous secondary cell at a low temperature increases.

### EXAMPLES

The present invention will be illustrated by the following Examples, which do not limit the scope of the present invention in any way.

In the Examples, “parts” are “parts by weight” unless otherwise indicated.

### Example 1

Artificial graphite was prepared by the following method and used as a negative electrode active material in this Example.

Coke powder (100 parts), tar pitch (40 parts), silicon carbide (14 parts) and coal tar (20 parts) were mixed at 200° C. in an air, milled and heated in a nitrogen atmosphere at 1000° C. and then at 3000° C. to obtain artificial graphite.

The graphite obtained had a BET specific surface area of 2.9 m²/g and a crystal spacing d₀₀₂ of 0.3362 nm.

Carbon black (CB 3050 (trade name) available from Mitsubishi Chemical Corporation) was treated with a tabletop blender so that it had an aspect ratio of 1.0 to 2.5 and the largest particle size of 1.0 μm or less.

Then the mixture of treated carbon black and artificial graphite was dry mixed with a HIVIS mixer with a capacity of 5 dm³ (manufactured by TOKUSHU KIKA KABUSHIKI KAISHA) at a peripheral speed of 0.25 m/sec. for 5 minutes. To the mixture, a 1.5 wt. % solution of carboxymethylcellulose in ion-exchanged water (hereinafter simply referred to as “water”) in an amount such that a solid content was adjusted to 48% by weight, and stirred at a peripheral speed of 0.40 m/sec for 30 minutes. Then, water was added to the mixture to adjust the solid content to 45% by weight. Thereafter, styrene-butadiene rubber was added to the mixture and stirred at a peripheral speed of 0.40 m/sec. for one hour to obtain a negative electrode coating containing graphite and carbon black dispersed therein. The weight ratio of graphite:carbon black:styrene-butadiene rubber:carboxymethyl cellulose was 97.5:0.5:1:1.

The negative electrode coating was applied to the both surfaces of a negative electrode collector consisting of a copper foil having a thickness of 10 μm, and dried to form a layer of a negative electrode mixture followed by press-forming with calender rolls to obtain the negative electrode of Example 1 having an electrode density of 1.61 g/cm³.

### Example 2

A negative electrode was produced in the same manner as in Example 1 except that the amount of carbon black was changed to 0.05% by weight based on the total weight of the solid. The negative electrode of this Example had an electrode density of 1.60 g/cm³.

### Example 3

A negative electrode was produced in the same manner as in Example 1 except that the amount of carbon black was changed to 0.1% by weight based on the total weight of the solid. The negative electrode of this Example had an electrode density of 1.5.9 g/cm³.

### Example 4

A negative electrode was produced in the same manner as in Example 1 except that the amount of carbon black was changed to 3.0% by weight based on the total weight of the solid. The negative electrode of this. Example had an electrode density of 1.60 g/cm³.

### Example 5

In the same HIVIS mixer as one used in Example 1, a 1.5 wt. % aqueous solution of carboxymethylcellulose and carbon black, which had been treated in the same manner as in Example 1, were charged and stirred at a peripheral speed of 0.40 m/sec. for 30 minutes to obtain a dispersion of carbon black in the aqueous solution of carboxymethylcellulose. The amount of carbon black was such that the solid content of carbon black in a final coating was 0.5% by weight, while the amount of the aqueous solution of carboxymethylcellulose was such that the solid content of carboxymethylcellulose in the final coating was 1% by weight.

Next, graphite in an amount of 97.5% by weight and styrene-butadiene rubber in an amount of 1% by weight were added to the dispersion of carbon black, and then water was added to the mixture in an amount such that the total solid content was 48% by weight during the mixing step. The whole mixture was further stirred at a peripheral speed of 0.40 m/sec. for 30 minutes.

Thereafter, the same procedures as those of Example 1 were repeated to obtain a negative electrode. The negative electrode of this Example had an electrode density of 1.60 g/cm³.

### Example 6

A negative electrode was produced in the same manner as in Example 1 except that only graphite was dispersed in a 1.5 wt. % aqueous solution of carboxymethylcellulose and then carbon black was added to the dispersion and stirred for 30 minutes to obtain a dispersion containing graphite, carbon black and carboxymethylcellulose. Here, the weight ratio of graphite:carbon black:styrene-butadiene rubber:carboxymethylcellulose was 97.5:0.5:1:1.

The negative electrode of this Example had an electrode density of 1.61 g/cm³.

### Comparative Example 1

A negative electrode was produced in the same manner as in Example 1 except that no carbon black was used. The negative electrode of this Comparative Example had an electrode density of 1.60 g/cm³.

### Comparative Example 2

We tried to produce a negative electrode in the same manner as in Example 1 except using a carbon black having an aspect ratio of 1.0 to 2.5 and a largest particle diameter of 32 μm. However, the particles formed into lumps and the coating could not be applied to a collector.

With each of the negative electrodes produced in Examples 1-6 and Comparative Example 1, the number of coating defects were counted in a rectangular area of 15 cm in length and 30 cm in width at a point of 0 m (start of calendering), 20 m or 40 m from the start of calendering of the negative electrode.

The results are shown in Table 1.

TABLE 1

| Example | Number of coating defects at | | |
|---|---|---|---|
| No. | 0 m | 20 m | 40 m |
| Example 1 | 0 | 0 | 0 |
| Example 2 | 0 | 0 | 2 |
| Example 3 | 0 | 0 | 0 |
| Example 4 | 0 | 0 | 0 |
| Example 5 | 0 | 0 | 0 |
| Example 6 | 0 | 0 | 0 |
| Comp. | 0 | 5 | 15 |
| Example 1 | | | |

| | |
|---|---|
| Comp. | Paste contains lumps |
| Example 2 | |

### Example 7

A positive electrode coating was prepared by mixing LiCoO₂ (92 parts) as a positive electrode active material, artificial graphite (4.5 parts) and carbon black (0.5 part) as conducting aids, polyvinylidene fluoride (3 parts) as a binder and N-methyl-2-pyrrolidone. This-coating was applied on the both surfaces of a positive electrode collector made of an aluminum foil having a thickness of 15 μm and dried to remove the solvent to obtain the layer of a positive electrode mixture, which was press shaped with calendering rolls to produce a positive electrode. An electrolytic solution was prepared by dissolving LIPF₆ in a mixed solvent of ethylene carbonate and ethylmethyl carbonate (volume ratio=1:2) in a concentration of 1.0 mol/dm³ and then adding cyclohexylbenzene to the solution in an amount of 2% by weight based on the whole weight of the electrolytic solution.

The positive electrode produced in the above step and the negative electrode of Example 1 were spirally wound with the inserting of a separator made of a microporous polyethylene film having a thickness of 20 μm between the electrodes and then pressed to form a flat-form wound electrode laminate. Then, the wound electrode laminate was installed in a prismatic cell case made of an aluminum alloy. Lead members were welded to the respective electrodes, and a lid plate was laser welded to the opening edge of the cell case. Through a pouring hole provided in the lid plate, the non-aqueous electrolytic solution was poured in the cell case, and the hole was sealed after the separator and the like were thoroughly impregnated with the electrolytic solution. After that, the cell was precharged and aged to obtain the non-aqueous secondary cell of Example 7, which had a structure shown in FIGS. 1A and 1B, and an exterior shown in FIG. 2. This cell had an energy density of 450 Wh/dm³.

In this cell, an insulator made of a polytetrafluoro-ethylene sheet was placed on the bottom of the cell case, the lid plate was made of an aluminum alloy. To the lid plate, a terminal made of stainless steel was attached through an insulating packing made of a tetrafluoroethylene-perfluoroalkyl vinyl ether copolymer, and lead plate made of stainless steel was connected to the terminal through an insulator.

### Example 8

A cell of Example 8 was produced in the same manner as in Example 7 except that the negative electrode of Example 2 was used.

### Example 9

A cell of Example 9 was produced in the same manner as in Example 7 except that the negative electrode of Example 3 was used.

### Example 10

A cell of Example 10 was produced in the same manner as in Example 7 except that the negative electrode of Example 4 was used.

### Comparative Example 3

A cell of Comparative Example 3 was produced in the same manner as in Example 7 except that the negative electrode of Example Comparative Example 1 was used.

Each of the cells of Examples 7-10 and Comparative Example 3 was charged under constant voltage and constant current conditions at a current corresponding to 1 CmA and a voltage of 4.2 V with a cut-off time of 20.5 hours. Just after charging, an impedance of 1 kHz at 25° C. was measured. The results are shown in Table 2.

TABLE 2

| | Ex. 7 | Ex. 8 | Ex. 9 | Ex. 10 | C. Ex. 3 |
|---|---|---|---|---|---|
| 1 KHz impedance (mΩ) | 41.1 | 42.5 | 41.6 | 41.5 | 42.9 |

As can be seen from the results of Table 2, the cells of Examples 7-10 had the lower impedance of 1 kHz than the cell of Comparative Example 3. This means that the cell of the present invention has a low internal resistance.

Each of the cells of Examples 7-10 and Comparative Example 3 was charged at 20° C. under constant voltage and constant current conditions at a current corresponding to 1 CmA and a voltage of 4.2 V with a cut-off time of 2.5 hours, and then the cell was discharged to 3 V at a current of 1 CmA at 20° C. In this step, a discharge capacity was measured. Next, the cell was charged at 20° C. under the same conditions as above and then kept in a thermostat vessel kept at −10° C. Then, the cell was discharged at a current of 1 CmA, and a discharge capacity at −10° C. was measured. Thereafter, a retention rate of capacity at −10° C. was calculated by the following equation:

Retention rate of capacity (%)=[(discharge capacity at −10° C.)/(discharge capacity at 20° C.)]×100

The results are shown in Table 3.

TABLE 3

| | Ex. 7 | Ex. 8 | Ex. 9 | Ex. 10 | C. Ex. 3 |
|---|---|---|---|---|---|
| Retention rate of | 58 | 54 | 56 | 59 | 52 |
| capacity at | | | | | |
| −10° C. (%) | | | | | |

As can be seen from the results of Table 3, the cells of Examples 7-10 had larger retention rates of capacity at −10° C. than that of Comparative Example 3. This means that the cell of the present invention has good low temperature properties.

### Example 11

The cell of Example 7 was installed in a mobile phone (“C 451H” (trade name) manufactured by Hitachi Ltd.) to set up a mobile phone of Example 11.

### Comparative Example 4

A mobile phone of Comparative Example 4 was set up in the same manner as in Example 11 except that the cell of Comparative Example 3 was used.

With the mobile phones of Example 11 and Comparative Example 4, a continuously speakable time at 20° C. and at −10° C. was measured. In this experiment, the discharge terminating voltage was 3.3 V. Then, a retention rate of speakable time at −10° C. was calculated by the following equation:

Retention rate of speakable time at −10° C. (%)=[(speakable time at −10° C.)/(speakable time at 20° C.)]×1.00

With the mobile phone of Example 11, the retention rate of speakable time at −10° C. was 55%, while with the mobile phone of Comparative Example 4, 46%. This means that the cell of the present invention has the improved low temperature properties when it is installed in an electronic device.

Each of the patent documents and publications that are referred to herein are incorporated herein by reference in their entirety.

What is claimed is:

1. A negative electrode for a non-aqueous secondary cell comprising graphite, carbon black and an aqueous binder, wherein said carbon black comprises particles having an aspect ratio of 1.0 to 5.0 and a largest particle size of 10 μm or less.

2. The negative electrode according to claim 1, wherein said graphite has an average particle size of from 15 to 30 μm, and at least 10% by weight of said carbon black, based on the total weight of the carbon black, has said aspect ratio: of 1.0 to 5.0 and said largest particle size of 10 μm or less.

3. The negative electrode according to claim 1, wherein said graphite has an average particle size of from 15 to 30 μm, and at least 60% by weight of said carbon black, based on the total weight of the carbon black, has said aspect ratio of 1.0 to 5.0 and a largest particle size of 1 μm or less.

4. The negative electrode according to any one of claims 1, 2 and 3, wherein said carbon black is present in an amount of from 0.1% to 3.0% by weight based on a final solids content of a negative electrode coating on said negative electrode.

5. The negative electrode according to claim 1, wherein said aqueous binder comprises styrene-butadiene rubber and carboxymethylcellulose.

6. The negative electrode according to claim 1, wherein said negative electrode has a density of at least 1.60 g/cm³, and said graphite has a specific surface area of at least 2.5 m²/g and a crystal spacing d₀₀₂ of 0.3370 nm or less.

7. A non-aqueous secondary cell comprising a positive electrode, a negative electrode and a non-aqueous electrolyte, wherein said negative electrode comprises graphite, carbon black comprising particles having an aspect ratio of 1.0 to 5.0 and a largest particle size of 10 μm or less, and an aqueous binder.

8. The non-aqueous secondary cell according to claim 7, wherein said graphite has an average particle size of from 15 to 30 μm, and at least 10% by weight of said carbon black, based on the total weight of the carbon black, has said aspect ratio of 1.0 to 5.0 and said largest particle size of 10 μm or less.

9. The non-aqueous secondary cell according to any one of claims 7 and 8, wherein said carbon black is present in an amount of from 0.1% to 3.0% by weight based on a final solids content of a negative electrode coating on said negative electrode.

10. The non-aqueous secondary cell according to claim 7, wherein said aqueous binder comprises styrene-butadiene rubber and carboxymethylcellulose.

11. The non-aqueous secondary cell according to claim 11, wherein said negative electrode has a density of at least 1.60 g/cm³ and said graphite has a specific surface area of at least 2.5 m²/g and a crystal spacing d₀₀₂ of 0.3370 nm or less.

12. A method for producing a negative electrode for a non-aqueous secondary cell comprising the steps of:
mixing graphite, carbon black comprising particles having an aspect ratio of 1.0 to 5.0 and a largest particle size of 10 μm or less, and an aqueous binder to prepare a negative electrode coating,
applying the negative electrode coating on a substrate of the negative electrode,
drying the applied negative electrode coating, and
press-forming the coating.

13. The method according to claim 12, wherein at least 10% by weight of said carbon black particles has said aspect ratio of 1.0 to 5.0, and said largest particle size of 10 μm or less.

14. The method according to claim 12, wherein said aqueous binder comprises styrene-butadiene rubber and carboxymethylcellulose.

15. The method according to claim 12, wherein said negative electrode has a density of at least 1.60 g/cm³, and said graphite has a specific surface area of: at least 2.5 m?/g and a crystal spacing d₀₀₂ of 0.3370 nm or less.

16. An electronic device comprising a non-aqueous secondary cell which comprises a positive electrode, a negative electrode and a non-aqueous electrolyte, wherein said negative electrode comprises graphite, carbon black comprising particles having an aspect ratio of 1.0 to 5.0 and a largest particle size of 10 μm or less, and an aqueous binder.

17. The electronic device according to claim 16, wherein said graphite has an average particle size of from 15 to 30 μm, and at least 10% by weight of said carbon black, based on the total weight of the carbon black, has said aspect ratio of 1.0 to 5.0 and said largest particle size of 10 μm or less.

18. The electronic device according to any one of claims 16 and 17, wherein said carbon black is present in an amount of from 0.1% to 3.0% by weight based on a final solids content of a negative electrode coating on said negative electrode.

19. The electronic device according to claim 16, wherein said aqueous binder comprises styrene-butadiene rubber and carboxymethylcellulose.

20. The electronic device according to claim 16, wherein said negative electrode has a density of at least 1.60 g/cm³, and said graphite has a specific surface area of at least 2.5 m²/g and a crystal spacing d₀₀₂ of 0.3370 nm or less.
